(19) United States
(12) Patent Application Publication
(10) Pub. No.: US 2011/0188868 A1
(43) Pub. Date: Aug. 4, 2011

(54) IMAGE FORMING APPARATUS AND A COLOR MATERIAL CONTROLLING METHOD

(75) Inventors: Kunihiro Shibuya, Shizuoka-ken (JP); Aiko Okajima, Shizuoka-ken (JP); Hideaki Fukaya, Shizuoka-ken (JP)

(73) Assignees: KABUSHIKI KAISHA TOSHIBA, Tokyo (JP); TOSHIBA TEC KABUSHIKI KAISHA, Tokyo (JP)

(21) Appl. No.: 13/011,011

(22) Filed: Jan. 21, 2011

Related U.S. Application Data
(60) Provisional application No. 61/300,163, filed on Feb. 1, 2010.

(30) Foreign Application Priority Data
Dec. 20, 2010 (JP) P2010-283653

(51) Int. Cl. G03G 15/01

(52) U.S. Cl. 399/28

(57) ABSTRACT

An image forming apparatus comprising: an attachment of a cartridge configured to accommodate a color material; a memory configured to memorize a current cartridge information which shows whether the cartridge attached to the attachment is a first cartridge which accommodates a first color material or a second cartridge which accommodates a second color material; and a controller configured to read the current cartridge information from said memory when the current cartridge attached to the attachment is exchanged to a new cartridge, further said controller configured to judge the new cartridge based on the current cartridge information read from said memory, further said controller configured to temporary stop initiating of a supply of the color material from the new cartridge until the color material supplied from the current cartridge remains in the image forming apparatus when the new cartridge is different from the current cartridge and said controller configured to initiate a supply of the color material from said new cartridge when the color material supplied from said current cartridge does not remain in the image forming apparatus.

### CROSS-REFERENCE TO RELATED APPLICATION

The application is based upon and claims the benefit of priority from U.S. Provisional Application No. 61/300,163, filed Feb. 1, 2010; further this application is based upon and claims the benefit of priority from Japanese Patent Application No. P2010-283653, filed on Dec. 20, 2010; the entire contents of which are incorporated herein by reference.

### FIELD

Embodiments of a present specification are related with an image forming apparatus and a color material controlling method.

### BACKGROUND

Toner cartridges of an image forming apparatus are consumable supplies, and it is necessary to replace with a new toner cartridge, when toner thereof is empty. This toner cartridge has two types, one (Recommended Article) is an article provided by a manufacturing company of the image forming apparatus, another one is an article (Generic Article) provided by a company except the manufacturing company of the image forming apparatus

The toner inside the recommended articles and the toner inside the generic articles are not at all the same. It is quite different on the printing quality etc. between the recommended articles and the generic articles. Therefore, it is preferably to execute a different control such as changing an interval of a cleaning and so on for keeping the same printing quality between the recommended articles and the generic articles.

Immediately after replacing toner cartridges, the toner of the toner cartridge before replacing still remains in the inside of a developing device or a carrying path of toner. In another words, in the case of the replacing toner cartridge when it comes to exchanging from the recommended article to the generic articles or exchanging from the generic articles to the recommended articles, there is possibility that the toner of the recommended article and the toner of the generic article may be mixed within the image forming apparatus.

Thus, if the toner of the recommendation article and the toner of the generic article are mixed, the suitable processing cannot be necessarily performed, thereby, the deterioration of print quality, etc. will be caused.

Therefore, it is an object of embodiments to provide an image forming apparatus which has fewer disadvantages for a user to use both a recommended toner cartridge and a generic toner cartridge.

### BRIEF DESCRIPTION OF THE DRAWINGS

FIG. 1 is a schematic diagram of an image forming apparatus with which one embodiment is applied.

FIG. 2 is a block diagram showing a processing unit of an image forming apparatus with which one embodiment is applied.

FIG. 3 is a flow chart at the time of an image forming apparatus in a 1st embodiment being equipped with a toner cartridge.

FIG. 4 is a flow chart at the time of an image forming apparatus in a 2nd embodiment being equipped with a toner cartridge.

### DETAILED DESCRIPTION

Hereafter, Embodiments relating to the invention is described, referring to drawings.

### First Embodiment

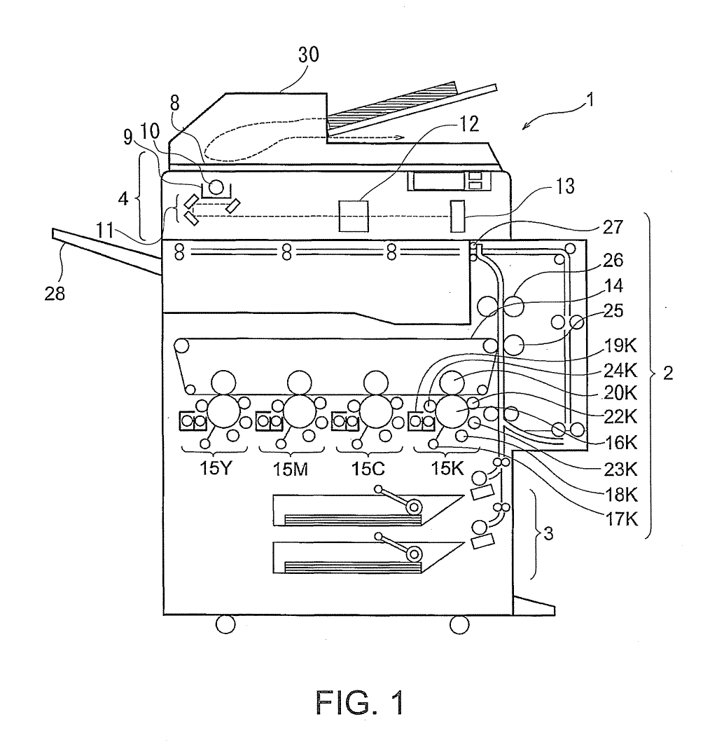

A 1st embodiment is described using FIG. 1 through FIG. 3. FIG. 1 is a sectional view showing roughly the image forming apparatus with which one embodiment of the present invention is applied.

An image forming apparatus 1 includes an image reading portion 4 which takes in a manuscript as image data, and an image forming portion 2 which outputs this image data as a visible image.

This image forming portion 2 has an image formation unit, which includes an image carrier, such as a drum-like photo conductor etc., as described herein below for example, and a fixing device etc.

The image forming apparatus 1 further includes a sheet supply portion 3 which can supply a paper P of optional size used as a recording medium of an image to the image forming portion 2.

The image reading portion 4 includes a penetrable manuscript mounting base 8, a carriage 9, an exposure lamp 10, a reflective mirror 11, an image forming lens 12 for converging the refractive light and a CCD (Charge Coupled Device) 13 which converts the image information of the refractive light into an analog signal.

Each image formation unit of yellow (Y), magenta (M), cyan (C), and black (K) which constitutes the image formation part 2 is the same composition, therefore, due to the same composition thereof, it will be explained by using an image formation unit 15 K of black (K) as an example.

The image formation unit 15 K is provided with a laser unit 17 K which forms an electrostatic latent image on a drum-like photo receptor 16 K as an image carrier, a charging unit 18 K, a developing unit 19 K, a cleaning unit 22K, and an electric discharge lamp 23 K, which is arranged one by one around the photo receptor 16 K

The manuscript to be copied is set on the manuscript mounting base 8 or on an automatic documents feeder which is heretofore known, arranged on the manuscript mounting base 8. On the case of pushing a copy button which is not illustrated, light from a lower part of the manuscript mounting base 8 is applied to the manuscript on the manuscript mounting base 8 or the manuscript sent to an exposure device of the manuscript mounting base 8 by the automatic documents feeder 30 by exposures means having the carriage 9 and the exposure lamp 10 disposed on the carriage 9. The reflected light from the manuscript is guided by the reflective mirror 11. Thereby, it is converged by the image forming lens 12, and the reflective light image is projected on the CCD 13. The light of the exposure lamp 10 scans a surface of the manuscript in synchronism with a movement of the carriage 9 (from the left to the right in FIG. 1). This scanned light is taken into the CCD 13 as image information, then after outputted with an analog signal, it is converted into a digital signal. After this, digitized image information is transmitted to the laser unit 17 K as an image data, after executing an image processing, if necessary. The image information converted into the digital signal may be temporary stored in a memory device such as a HDD (Hard Disc Drive) and so on.

In image formation portion 2, when an image is started to be formed, the charging unit 18K supplies an electric charge to the peripheral face of the rotating photo receptor 16 K, and the outside of the photo receptor 16 K. is charged in uniform electrical potential.

Next, the laser unit-17K radiates a laser beam modulated by the image data transmitted from the CCD 13 toward the outside of the photo receptor 16K. This laser beam is scanned along the rotating shaft of the drum-like photo receptor, and then the electrostatic latent image corresponding to an image data is formed and held in the peripheral face of the rotating photo receptor 16 K.

Further, on the peripheral surface of the photo receptor 16 K, it is provided with a developer of a color material such as toner etc. by the developing device 19 K. Consequently, an electrostatic latent image is converted to a toner image, namely a developing image.

This developing unit 19 K is provided with a developing roller 24 K formed to be able to freely rotate. Thereby, when the developing roller 24 K is disposed in the opposite side, it rotates; toner is supplied to the photo receptor 16 K.

When a toner image is formed on the peripheral surface of the photo receptor 16 K, a toner image is electrostatically transferred to an intermediate transfer belt 14 by a first transfer roller 20 K as a transfer unit contacting the photo receptor 16 K via the intermediate transfer belt 14.

The toner on the photo receptor 16 K which remained without being transferred is removed from the first transfer roller 20 K by the cleaning roller 22 K located downstream in the direction of the rotation of the photo conductor 16 K. In addition, the remnant charge of the peripheral surface of the photo receptor 16 K is further removed by an electric discharge lamp 23 K. When forming a color picture, the above-mentioned operation is similarly performed in the image formation units 15 Y, 15 M, and 15 C.

The toner image transferred by the intermediate transfer belt 14 is electrostatically transferred on a paper which is conveyed from the paper sheet supply portion 3 through a carrying path by a secondary transfer roller 25. Then, a paper P in which the toner image was transferred is conveyed to a fixing device 26 and the toner image transferred on the paper is fixed on the paper by the fixing device 26. The paper where the toner image was fixed and where the image formation is completed is ejected on a paper tray 28 as an ejecting unit by a carrying roller 27.

Hereinbefore, the outline of the operation of forming an image on a paper as a recording medium is described.

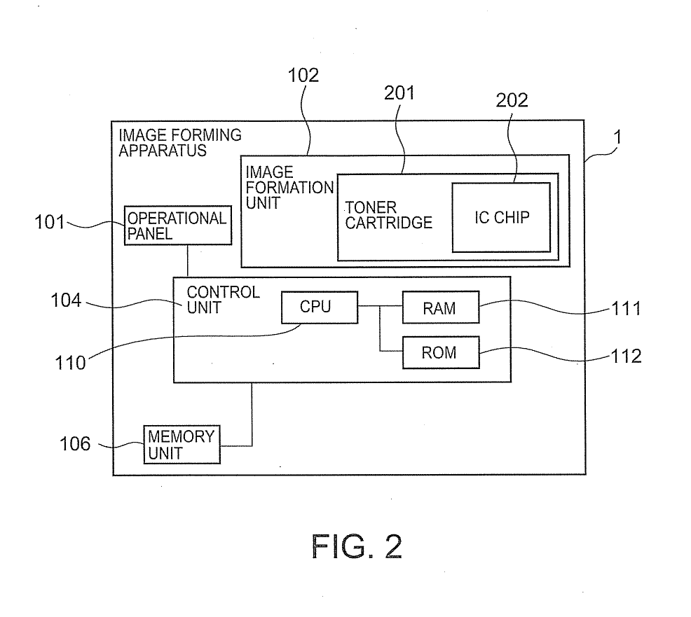

Next, the control system of the image forming apparatus 1 concerning this embodiment is explained. FIG. 2 is a block diagram of the control system of the image forming apparatus 1 in this embodiment.

The image forming apparatus 1 is provided with an operational panel (a display) 101, an image formation unit 102, a control unit 104, a memory unit 106, etc. The operational panel 101 is a user interface which has a touch panel, for example, in which an operation instruction from a user is inputted. The operational panel 101 has a hard key such as a numerical keypad or a touch key such as a display device in a built-in touch panel. Thereby, the input of the operation instruction from a user is executed. A PC (Personal Computer) is able to connect with the image forming apparatus 1 via a LAN (Local Area Network) or an Internet Network as an external terminal, and the user can send the drawn-up manuscript to the image forming apparatus 1 on the PC, and it can be printed. Additionally, a message from the image forming device 1 is received, or the response of a message can be performed to the image forming device 1.

The image formation unit 102 has an attachment unit for attaching the cartridge accommodated a color material such as toner, and a toner cartridge 201 is attached to the attachment unit. The recommended toner cartridge (a first cartridge) accommodated the recommended toner provided by the manufacturing company of the image forming apparatus 1 has an IC chip 202, for example. This IC chip 202 as a recording member memorizes the information for identifying a recommended article.

A generic article cartridge (a second cartridge) accommodated the generic toner provided by the other manufacturing company except one of the image forming apparatus 1 does not have the IC chip (202). Otherwise, there may be a case that the generic cartridge does not memorize the identifying information of the recommended article on the IC chip 202, in spite of equipping with the IC chip 202.

A control unit 104 is provided with a CPU (Central Processing Unit) 110, a RAM (Random Access Memory) 111, and a ROM (Read Only Memory) 112.

The CPU 110 is a processor which totally controls of the control unit 104. A RAM 111 is a memory which temporary memorizes data for working, or memorizes the data for reference. A ROM 112 is a nonvolatile memory, and a control program, control data, etc. for controlling the image forming apparatus 1 are stored. The CPU 110 executes various processing and various functions by operating based on the control program memorized in the ROM 112.

In addition, although the CPU 110 is used as a processor, the kind of processor is not restricted to this.

The memory unit 106 memorizes cartridge information for currently using, which information shows whether the toner cartridge which is currently attached, is the recommended toner cartridge or the generic toner cartridge. In addition, the memory unit 106 further memorizes the used cartridge information before exchanging as current cartridge information, which information shows whether the toner cartridge before exchanging is the recommended toner cartridge or the generic toner cartridge.

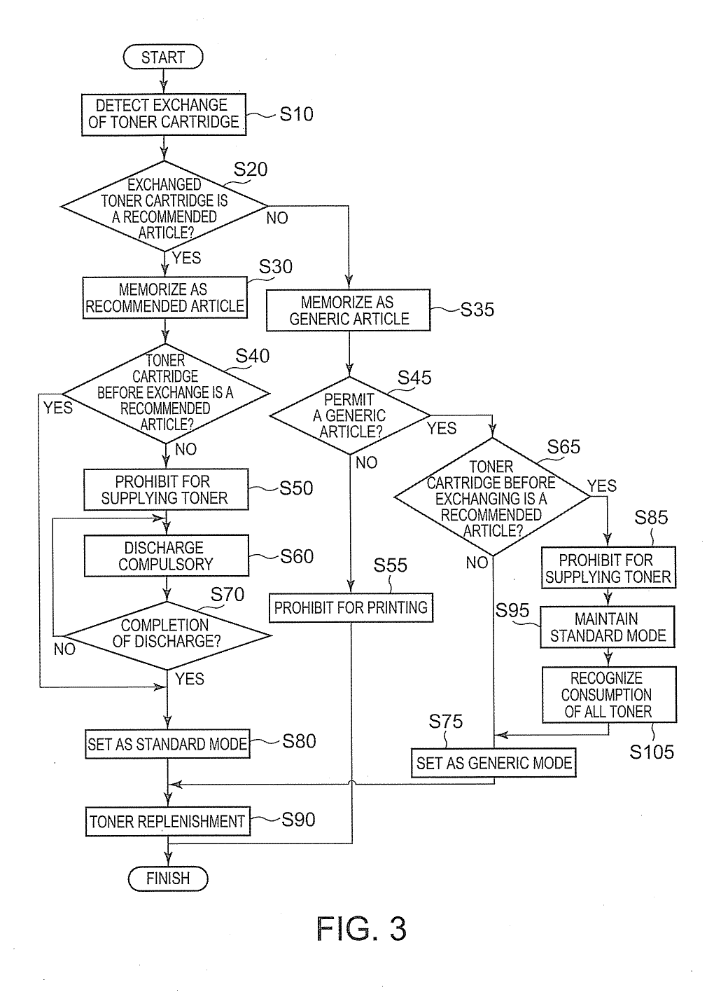

FIG. 3 is a flow chart which shows the control at the time of exchanging toner cartridges.

When the CPU 110 detects exchanging of the toner cartridge 201 (S10), the CPU 110 reads the information on the IC chip 202 mounted on the toner cartridge 201 and judges whether the attached toner cartridge 201 is the recommended article or not (S20). From the information written in the IC chip 202, it is judged as the recommended article (S20: Yes), and then as current using cartridge information, the recommended article is memorized in the memory unit 106 (S30). This using cartridge information is kept to store in the memory unit 106 at least until the toner cartridge is exchanged next. Then if the toner cartridge 201 is exchanged next, it is referred as the current toner cartridge before exchanging.

Next, the CPU 110 reads the current cartridge information before the exchange memorized by the memory unit 106, and judges whether the toner cartridge 201 before exchange is a recommended article (S40).

If it is judged that toner cartridge 201 before exchange is not a recommended article (S40: No), replenishment of toner from the exchanged toner cartridge 201 is prohibited. After this, the CPC 110 compulsory discharges the remained toner in the developing unit (S60).

After executing compulsory discharging of toner, a toner sensor disposed in the developing device detects whether the discharge of the toner in the developing device is completed or not (S70). In addition, it is not necessary to limit to detect by the toner sensor in the developing device when judging the completion of the discharging toner or not, it may be judged by detecting the volume of adhesion toner of a test path in executing the image forming operation.

If the CPU 110 judges that discharge of toner in the developing device is completed (S70: Yes), a judgment mode for toner deterioration degree is set to be as a standard mode (The first mode) (S80). The judgment mode for toner deterioration degree will be mentioned later. And a replenishment of toner from the attached toner cartridge is started (S90).

Next, in Step 20, the case (S20: No) where it is detected as not being a recommended article is explained. When it is detected as not being the recommended article, the memory unit 106 memorizes a generic article as current use cartridge information therein (S35).

Then, the CPU 110 judges whether a user permits printing with a generic article (S35). The CPU 110 reports that the exchanged toner cartridge is a generic article, a user can select to whether permitting to print with a generic article from the operational panel 101 etc. (Response Information).

In Step 45, when a user does not permit printing with a generic article (S45: No), the CPU 110 prohibits a printing operation (S55). At this time, the operation except the printing operation is not objected for prohibiting.

In Step 45, when a user permits printing with a generic article (S45: Yes), the CPU 110 judges whether the toner cartridge before exchanging is a recommended article or not (S65). In Step 65, when it is judged that the toner cartridge is before exchanging is a generic article (S65: No), the judgment mode for toner deterioration degree is set to be a generic mode (a second mode) (S75), and the replenishment of toner from the attached toner cartridge is started (S90).

In Step 65, when the toner cartridge before exchanging is judged as a recommended article (S65: Yes), the CPU 110 prohibits the replenishment from the toner cartridge (S85). At this time, due to remain the recommended toner in the developing device, if the generic toner from the exchanged generic toner cartridge is supplied, the recommended toner and the generic toner are mixed. Therefore, at this time, because the toner in the developing device is the recommended toner, the compulsory discharging is not executed, and it is kept to use the toner until the exhaustion of the toner in the developing device. Thus, the judgment mode for toner deterioration degree is maintained to set to be the standard mode (S95).

Then, if the CPU 110 recognizes that the toner in the developing device is exhausted completely for use (S105), the judgment mode for toner deterioration degree is to set to be the generic mode (S75). Then, the replenishment of the toner from the attached toner cartridge is started (S90).

Hereinafter, the judgment mode for toner deterioration degree is explained. In general, it is different from the recommended toner included in the recommended toner cartridge and the generic toner included in the generic toner cartridge on physical properties; as a result, it is assumed that the deterioration of the generic toner is faster than one of the recommended toner. Therefore, it is desirable that the frequency etc, of the toner refreshment is adjusted for each the recommended toner or the generic toner.

So in this embodiment, according to the toner type of the developing device, the judgment mode for toner deterioration degree is set. Then, based on the judgment mode for toner deterioration degree, the frequency of the toner refreshment is changed. When using the recommended toner, the judgment mode for toner deterioration degree is set to be the standard mode. Contrary, when using the generic mode, the judgment mode for toner deterioration degree is set to be the generic mode.

The executing interval. D of the toner refreshment is individually set to be based on each judgment mode for toner deterioration degree. In the standard mode, the executing interval D of the toner refreshment is set to be D1, in the generic mode, the executing interval D is set to be D2. In this case, the relationship: D2<D1 is approved. That is, in the generic mode, the toner refreshment of the generic mode is more frequently executed than one of the standard mode.

The frequency of executing the toner refreshment is explained in detail. The CPU 110 memorizes the time and the date in the memory unit 106 at the time the toner refreshment is executed.

And when executing the toner refreshment at the next time, the CPU 110 acquires the current time and date. Then, the CPU 110 calculates the elapse time T elapsed from the time when the toner refreshment is executed at the last time, based on the difference of the time and date of the toner refreshment at the last time stored in the memory unit 106.

The CPU 110 distinguishes the judgment mode for toner deterioration degree which is set up. When the judgment mode for toner deterioration degree is the standard mode, it compares the elapsed time T with the executing interval D1. Then, in the case of the relationship: T≧D1, the toner refreshment is executed. However, if it is in the middle of printing of the image forming apparatus 1, the toner refreshment is executed after the printing completion. In addition, it is not after the printing completion, but an interrupt process regarding printing may be executed during printing, then the toner refreshment may be executed.

If the CPU 101 judges that the toner judgment mode is the generic mode, the CPU 101 compares the elapsed time with the T with the executing interval D2. Then, in the case of the relationship: T≧D2, the toner refreshment is executed. As well as the standard mode, if it is in the middle of printing of the image forming apparatus 1, the toner refreshment is executed after the printing completion.

Additionally, in this embodiment the executing interval of the toner refreshment is changed based on the standard mode or the generic mode. It may be acceptable if the control on each toner of the standard toner or the generic toner is properly performed. For example, in each the judgment mode for toner deterioration degree, the time of the toner refreshment at one time may be changed, and the volume of the toner which is discharged at one time may be changed.

According to the above mentioned embodiment, the CPU 101 judges whether the exchanged toner cartridge (New Cartridge) after exchanging the toner cartridge coincides with the toner cartridge (Current Cartridge) before exchanging. Then when not coincide, the CPU 101 prohibits the toner replenishment from the attached toner cartridge, and the toner replenishment is executed after confirming that the toner before exchanging in the developing device is exhausted. Thereby, it can prevent from mixing the toner before exchanging and the toner after exchanging.

Additionally, the toner in the image forming apparatus may be remained in some degree, unless printing quality is greatly deteriorated. For example, the toner replenishment is executed after confirming that the toner before exchanging does not remain in the image forming apparatus more than a predetermined volume. The predetermined volume is determined by the degree of deteriorated quality and so on.

Further, a toner management mode is determined to each one, according to the judgment whether the exchanged toner cartridge is the recommended article or the generic article. Thereby, it can be most properly controlled when using the toner having different properties.

Especially, when the new cartridge is the generic article and the current cartridge is the recommended article, it stops to supply the generic toner from the new cartridge, until the recommended toner supplied from the current cartridge is exhausted. Thereby, the recommended toner is used efficiently.

### A Second Embodiment

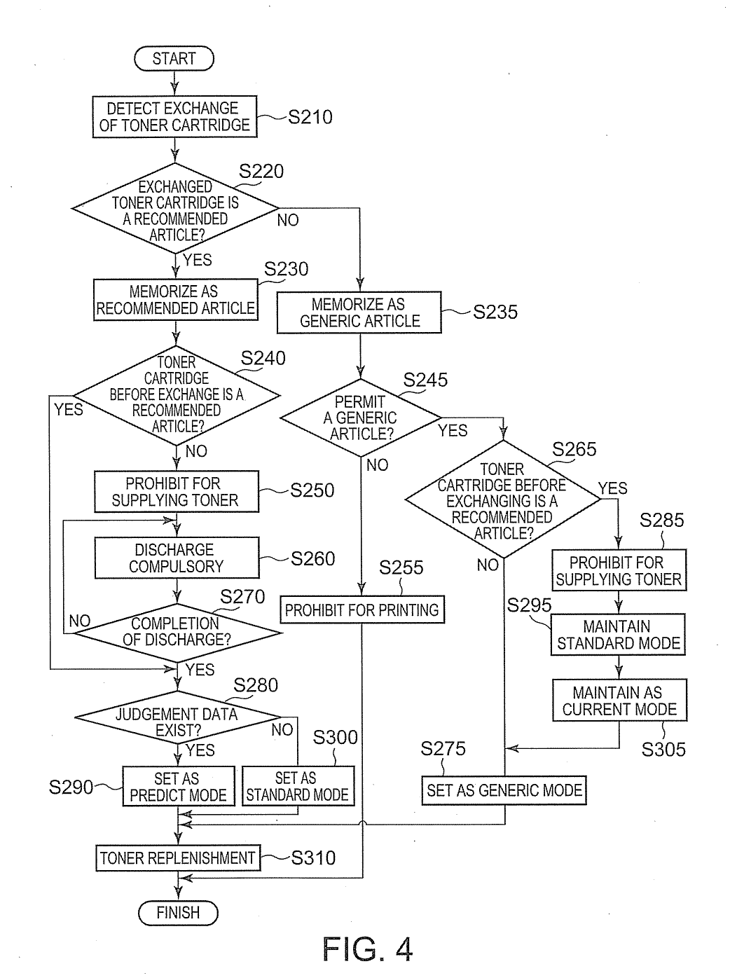

A second embodiment is described by using FIG. 4. Hereafter, only the characterizing portion of this embodiment is explained by using the same symbols and numerals to the same portion of the 1st embodiment.

In this embodiment, the toner cartridge of the recommended article with which image forming apparatus 1 is equipped is provided with an IC chip as a memory member. Toner has a fluctuation in the physical properties on each production lot to some extent within a scope which is assumed. Therefore, the information in regard to the toner property of the production lot etc. is memorized in the IC chip of the toner cartridge as the judgment data for the toner deterioration degree.

When the judgment data for the toner deterioration degree is recognized, even if it is the same recommended article, based on the judgment data for the toner deterioration degree including the information in regard to the toner property described in this embodiment as mentioned above, the judgment mode for the toner deterioration degree adapts the predicting mode (the third mode). In the predicting mode a process can be executed more suitably than the standard mode used in the recommended article.

This embodiment is described using the flow chart of FIG. 4.

Step 210-Step 270 are corresponding to Step 10-Step 70 of the flow chart in FIG. 3 showing the first embodiment, and Step 235-Step 285 are corresponding to Step 35-Step 85 of the flow chart in FIG. 3 showing the first embodiment. Therefore, the explanation is omitted.

In Step 280, the CPU 110 reads the IC chip of the recommended article in the toner cartridge and it judges whether the judgment data for toner deterioration degree exists or not. In Step 280, when the CPU 110 judges an existence of the judgment data for the toner deterioration degree (S280: Yes), the judgment mode for the toner deterioration degree is set to be as the predicting mode (S290).

In Step 280, when the judgment data for the toner deterioration degree does not exist (S280: No), the judgment mode for the toner deterioration degree is set to be as the standard mode. The standard mode is a management mode, for properly controlling the toner, uniformly defined to the recommended toner

In addition, when the exchanged toner cartridge is the generic article and the toner cartridge before exchanging is the recommended article (S265: Yes), the replenishment of the toner to the developing device is stopped for not mixing the recommended toner and the generic toner. (S285). After that, in Step 295, the mode which is currently designated is maintained as the judgment mode for the toner deterioration degree.

By taking the above mentioned embodiment, when the recommended toner cartridge is used, further a most suitable toner control can be achieved in considering the toner property such as the production lot and so on.

In the first and second embodiments, toner is illustrated and explained by an example as a color material. However, this embodiment is also applicable to an ink jet recording device using ink as a color material. Further, the same effect can be acquired.

While certain embodiments have been described, these embodiments have been presented by way of example only, and are not intended to limit the scope of the inventions. Indeed, the novel methods and systems described herein may be embodied in a variety of the other forms; furthermore, various omissions, substitutions and changes in the form the methods and systems described herein may be made without departing from the sprit of the inventions. The accompanying claims and their equivalents are intended to cover such forms or modifications as would fall within the scope and spirit of the inventions.

What is claim is:

1. An image forming apparatus comprising:
an attachment of a cartridge configured to accommodate a color material;
a memory configured to memorize a current cartridge information which shows whether the cartridge attached to the attachment is a first cartridge which accommodates a first color material or a second cartridge which accommodates a second color material; and
a controller configured to read the current cartridge information from said memory when the current cartridge attached to the attachment is exchanged to a new cartridge, further said controller configured to judge the new cartridge based on the current cartridge information read from said memory, further said controller configured to temporary stop initiating of a supply of the color material from the new cartridge until the color material supplied from the current cartridge remains in the image forming apparatus when the new cartridge is different from the current cartridge and said controller configured to initiate a supply of the color material from said new cartridge when the color material supplied from said current cartridge does not remain in the image forming apparatus.

2. The image forming apparatus as set forth in claim 1:
wherein when said first color material is a recommended color material, said second color material is a generic color material which is different from the recommended color material, the new cartridge is the first cartridge and the current cartridge has the second color material,
the color material, supplied from the current cartridge, remained in the image forming apparatus is compulsory discharged.

3. The image forming apparatus as set forth in claim 2 further comprising:
a sensor configured to detect a completion of discharging the color material, when said color material is compulsory discharged

4. The image forming apparatus as set forth in claim 1:
wherein when said new cartridge is the first cartridge, the color material is controlled in a first mode which is suitable for the first color material accommodated in the first cartridge, further wherein when said new cartridge is the second cartridge, the color material accommodated in the second cartridge is controlled in a second mode which is different from the first mode.

5. The image forming apparatus as set forth in claim 4:
wherein the first mode and the second mode is different on an interval of a refreshment of the color material.

6. The image forming apparatus as set forth in claim 4:
wherein the first mode and the second mode is different on a time of a refreshment of the color material.

7. The image forming apparatus as set forth in claim 1:
wherein said first cartridge includes a recorder, an identification information is stored in the recorder,
said controller judges, at a time when said new cartridge is attached to said attachment, if said identification information of said recorder is recognized, the new cartridge is the first cartridge, and if said identification information is not recognized, the new cartridge is the second cartridge.

8. The image forming apparatus as set forth in claim 4:
wherein said first cartridge includes a recorder, an identification information including in said first cartridge is stored in the recorder,
if said controller recognizes the information of said color material, said color material is controlled by a third mode based on information of the color material.

9. The image forming apparatus as set forth in claim 4:
wherein if the new cartridge attached to said attachment and the current cartridge discharged from said attachment are the same, without prohibiting a initiation of a supply of the color material the color material is controlled by the same mode as the mode which controls the color material from the current cartridge.

10. A color material controlling method comprising:
detecting whether a cartridge which accommodates a color material is exchanged or not;
judging whether the cartridge is a first cartridge which accommodates a first color material or a second cartridge which accommodates a second color material; and
when a color material of a new cartridge after exchanging is different from a color material of an old cartridge before exchanging,
stopping temporary a supply of the color material from the new cartridge at a time when the color material supplied from the old cartridge remains in the image forming apparatus.

11. The color material controlling method as set forth in claim 10 further comprising:
supplying the color material from said new cartridge, when the color material supplied from said old cartridge does not remain in the image forming apparatus more than a predetermined volume.

12. The color material controlling method as set forth in claim 11:
wherein when said first color material is a recommended color material, said second color material is a generic color material which is different from the recommended color material, the new cartridge is the first cartridge and the old cartridge has the second color material, the color material, supplied from the old cartridge, remained in the image forming apparatus is compulsory discharged.

13. The color material controlling method as set forth in claim 11:
wherein when said new cartridge is the first cartridge, the color material is controlled in a first mode which is suitable for the first color material accommodated in the first cartridge,
further wherein when said new cartridge is the second cartridge, the color material accommodated in the second cartridge is controlled in a second mode which is different from the first mode.

14. The color material controlling method as set forth in claim 13:
wherein the first mode and the second mode is different on an interval of a refreshment of the color material.

15. The color material controlling method as set forth in claim 10:
wherein said first cartridge includes a recorder and an identification information is stored in the recorder,
and further wherein at a time when said new cartridge is attached, if said identification information of said recorder is recognized, the new cartridge is judged as the first cartridge,
if said identification information is not recognized, the new cartridge is the second cartridge.

16. The color material controlling method as set forth in claim 13:
wherein said first cartridge includes a recorder and an identification information including in said first cartridge is stored in the recorder,
further wherein if the information of said color material is recognized, said color material is controlled by a third mode based on information of the color material.

17. The color material controlling method as set forth in claim 13:
wherein if the new cartridge and the old cartridge are the same, without suspending a initiation of a supply of the color material, the color material is controlled by the same mode as the mode which controls the color material from the old cartridge.

18. An image forming apparatus for forming an image by using a color material supplied from an exchangeable cartridge comprising:
a judging unit configured to judge whether the cartridge accommodates a first color material or a second color material which is different from the first color material;
a recognizing unit configured to recognize that a new cartridge after exchanging has the different color material from one of an old cartridge before exchanging based on a result of said judging unit; and
a control unit configured to discharge the color material supplied from the old cartridge before supplying the color material from the new cartridge when said recognizing unit recognizes that the color material is different.

19. The image forming apparatus as set forth in claim 18:
wherein when said first color material is a recommended color material, said second color material is a generic color material which is different from the recommended color material, the new cartridge accommodates the second color material and the old cartridge accommodates the first color material,
a supply of the color material from the new cartridge is temporally suspended at the time when the color material supplied from the old cartridge remains in the image forming apparatus, and the color material from the new cartridge is supplied when the color material from the old cartridge does not remain in the image forming apparatus more than a predetermined volume.

20. The image forming apparatus as set forth in claim 18:
wherein when said first color material is a recommended color material, said second color material is a generic color material which is different from the recommended color material, the old cartridge accommodates the second color material and the new cartridge accommodates the first color material, the color material remained in the image forming apparatus is compulsory discharged.
